(19) United States
(12) Patent Application Publication
(10) Pub. No.: US 2021/0248186 A1
(43) Pub. Date: Aug. 12, 2021

(54) OPTIMIZATION APPARATUS, OPTIMIZATION METHOD, AND STORAGE MEDIUM

(71) Applicant: FUJITSU LIMITED, Kawasaki-shi (JP)

(72) Inventors: Toshiyuki Miyazawa, Kawasaki (JP); Takayuki Shibasaki, Kawasaki (JP)

(73) Assignee: FUJITSU LIMITED, Kawasaki-shi (JP)

(21) Appl. No.: 17/166,005

(22) Filed: Feb. 3, 2021

(30) Foreign Application Priority Data
Feb. 10, 2020 (JP) 2020-020534

(51) Int. Cl. G06F 16/903; G06F 17/10

(52) U.S. Cl. CPC G06F 16/903; G06F 17/10

(57) ABSTRACT

An optimization apparatus, includes a memory; and a processor coupled to the memory and configured to: extract a set of variables satisfying a part of constraint conditions of a combinatorial optimization problem based on problem data indicating the combinatorial optimization problem, generate an evaluation function with the reduced constraint conditions based on the problem data and the extracted set of variables, and execute a search for a ground state for the generated evaluation function.

### CROSS-REFERENCE TO RELATED APPLICATION

This application is based upon and claims the benefit of priority of the prior Japanese Patent Application No. 2020-20534, filed on Feb. 10, 2020, the entire contents of which are incorporated herein by reference.

### FIELD

The embodiments discussed herein are related to an optimization apparatus, a control method, and a storage medium.

### BACKGROUND

In order to solve the combinatorial optimization problem, the problem is converted into an evaluation function, and a combination (ground state or optimal solution) that minimizes (or maximizes) the evaluation function searched for among combinations of values of state variables included in the evaluation function.

In the combinatorial optimization problem, since each state variable takes only a discrete value, it is not possible to use a method for reaching an optimal solution by continuously changing the state variable in a direction in which an evaluation function is improved. There are many local solutions in the combinatorial optimization problem. Therefore, it takes a long time to obtain an accurate solution.

As a method for acquiring a solution dose to an optimal solution of a combinatorial optimization problem in a practical amount of time, a simulated annealing method and Markov chain Monte Carlo methods such as a replica exchange method (also called “exchange Monte Carlo method”) have been known, for example. A method using quantum annealing method has also been known.

In a case where the problem is converted into the Ising model, which is an example of the evaluation function, there is a method of detecting whether or not the Ising model correctly reflects the properties of the original problem by using constraint conditions obtained at the time of the conversion.

A scenario-based optimization method is known. When constraints are too hard to obtain a solution, there is a method of changing scenarios to relax constraints. As related art, Japanese National Publication of International Patent Application No. 2016-531343, International Publication Pamphlet No. WO 2017/017807, and Japanese National Publication of International Patent Application No. 2018-519607 are known.

### SUMMARY

According to an aspect of the embodiments, an optimization apparatus, includes a memory; and a processor coupled to the memory and configured to: extract a set of variables satisfying a part of constraint conditions of a combinatorial optimization problem based on problem data indicating the combinatorial optimization problem, generate an evaluation function with the reduced constraint conditions based on the problem data and the extracted set of variables, and execute a search for a ground state for the generated evaluation function.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an optimization apparatus according to a first embodiment;

FIG. 2 is a flowchart illustrating a flow of an example of a control method for the optimization apparatus according to the first embodiment;

FIG. 3 is a diagram illustrating an example of hardware of an optimization apparatus according to a second embodiment;

FIG. 4 is a diagram illustrating another example of hardware of the optimization apparatus according to the second embodiment;

FIG. 5 is a block diagram illustrating a function example of the optimization apparatus according to the second embodiment;

FIG. 6 is a diagram illustrating an example of a depot, nodes, and a route in a capacitated vehicle routing problem (CVRP);

FIG. 7 is a flowchart illustrating a flow of an example of a control method for the optimization apparatus according to the second embodiment;

FIG. 8 is a diagram illustrating exemplary sorting of demands;

FIG. 9 is a diagram illustrating whether or not a truck is present at each node at each time when a combination of the numbers of nodes that each truck is able to visit is 4, 4, 3, 1;

FIG. 10 is a diagram illustrating whether or not a truck is present at each node at each time when a combination of the numbers of nodes that each truck is able to visit is 4, 4, 2, 2;

FIG. 11 is a diagram illustrating whether or not a truck is present at each node at each time when a combination of the numbers of nodes that each truck is able to visit is 4, 3, 3, 2;

FIG. 12 is a diagram illustrating whether or not a truck is present at each node at each time when a combination of the numbers of nodes that each truck is able to visit is 4, 3, 3, 3;

FIG. 13 is a diagram illustrating an example of state variables to be deleted;

FIG. 14 is a flowchart illustrating an example of a procedure of a process for extracting combinations of the numbers of nodes that each truck is able to visit (Part 1);

FIG. 15 is a flowchart illustrating the example of the procedure of the process for extracting combinations of the numbers of nodes that each truck is able to visit (Part 2); and

FIG. 16 is a diagram illustrating an example of a calculation result of a CVRP in a case of k=4, n=12, Q=6000.

### DESCRIPTION OF EMBODIMENTS

Some combinatorial optimization problems include many constraint conditions, and the evaluation function obtained by converting such a problem includes a constraint term corresponding to each constraint condition. Since an evaluation function including many constraint terms has a complex potential shape including many local maximum values and local minimum values, there is a problem that convergence to an optimal solution is degraded. For example, in the simulated annealing method or the replica exchange method, as the number of constraint terms increases, the number of potential barriers to be overcome in the process of transition to the optimal solution increases, and thus the time taken to reach the optimal solution also increases. In consideration of the above, it is desirable to provide an optimization apparatus, a control method for the optimization apparatus, and a control program of the optimization apparatus capable of improving convergence of a combinatorial optimization problem to an optimal solution.

Hereinafter, embodiments are described below with reference to the drawings.

### First Embodiment

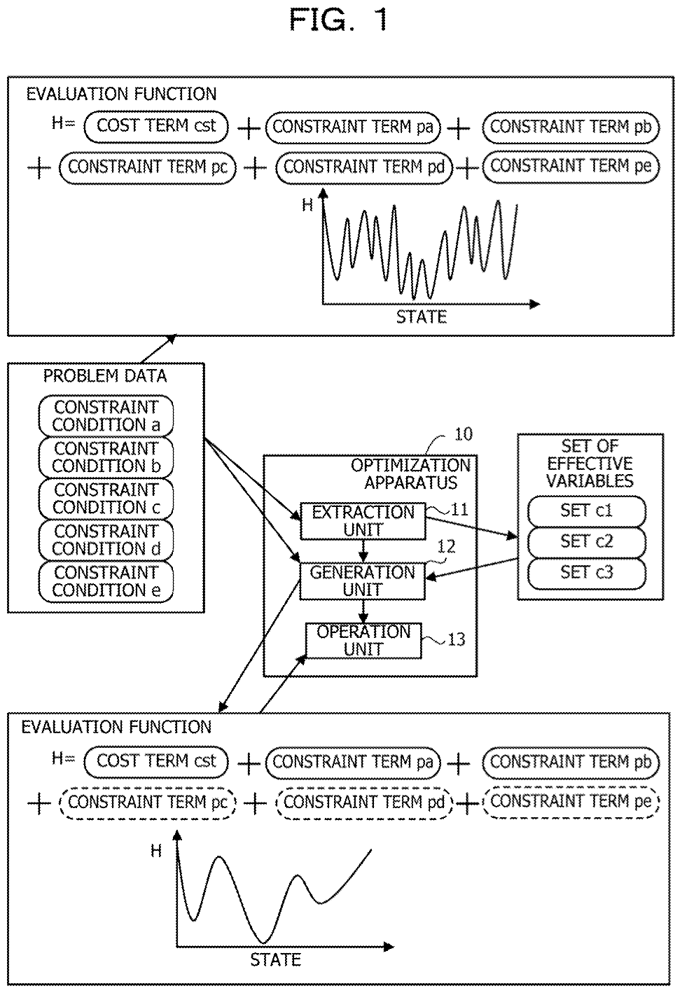

FIG. 1 is a diagram illustrating an example of an optimization apparatus according to a first embodiment.

The optimization apparatus 10 according to the first embodiment includes an extraction unit 11, a generation unit 12, and an operation unit 13.

The extraction unit 11 extracts a set of variables satisfying apart of constraint conditions of a combinatorial optimization problem based on problem data indicating the combinatorial optimization problem to be calculated.

An example of the combinatorial optimization problem to be calculated is a routing problem of a plurality of nodes such as a capacitated vehicle routing problem (CVRP). The CVRP is a problem for obtaining a customer visiting order (route) that minimizes a total movement distance or the like based on various input variables when a demand is delivered (or collected) to a customer position (hereinafter referred to as a node) by a transport vehicle waiting at a specific facility called a depot and returns to the depot again. In the CVRP, as the constraint conditions, there are a large number of constraint conditions, for example, including a condition that a total demand amount (hereinafter referred to as a demand) of nodes in the entire route excluding a depot on the route is within a maximum load capacity of one transport vehicle.

Although details will be described later, for example, in the CVRP, it is possible to determine an effective combination for the number of nodes through which each transport vehicle passes, from the maximum load capacity of each transport vehicle and the demand at each node. Such an effective combination of the numbers of nodes satisfies a part of the constraint conditions. The set of variables satisfying a part of the constraint conditions is not limited to an effective combination of the numbers of nodes.

The generation unit 12 generates an evaluation function with reduced constraint conditions based on the problem data and the extracted set of the variables. The evaluation function with reduced constraint conditions is an evaluation function that does not include constraint terms corresponding to a part of the constraint conditions satisfied by the set of extracted variables. Various variables (for example, the maximum load capacity of the transport vehicle, the distance between nodes, the demand of each node, and the like) included in the evaluation function are set based on the problem data. Based on the extracted set of variables, the values of some state variables (a part of the constraint conditions are not satisfied when the value of the state variable is 1) among the plurality of state variables included in the evaluation function are fixed to 0. Instead of fixing the values of some state variables to 0, the state variables themselves may be deleted.

The operation unit 13 executes a search for a ground state for the generated evaluation function. The operation unit 13 may perform the search for the ground state by the simulated annealing method or the Markov chain Monte Carlo method such as the replica exchange method or may perform the search for the ground state by the quantum annealing method. A state (a combination of values of all state variables of the evaluation function) that is the solution output as the search result is a state with which the value of the evaluation function is minimum among states updated many times within a predetermined time, for example.

The extraction unit 11, the generation unit 12, and the operation unit 13 may be implemented by using program modules executed by a processor such as a central processing unit (CPU) or a digital signal processor (DSP). The operation unit 13 may be hardware that executes the simulated annealing method or the replica exchange method by using a digital circuit or may be hardware that performs quantum annealing.

An example of operations of the optimization apparatus 10 (control method for the optimization apparatus 10) according to the first embodiment will be described below.

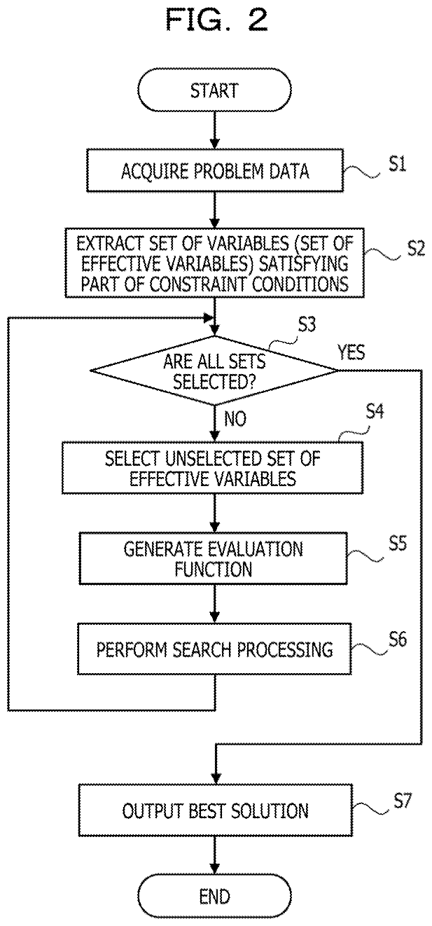

FIG. 2 is a flowchart illustrating a flow of an example of a control method for the optimization apparatus according to the first embodiment.

When an input unit (not illustrated) of the optimization apparatus 10 acquires problem data (step S1), the extraction unit 11 extracts sets of variables (hereinafter, referred to as sets of effective variables) satisfying a part of the constraint conditions based on the problem data (step S2).

For example, as illustrated in FIG. 1, the combinatorial optimization problem to be calculated includes constraint conditions a, b, c, d, and e. The extraction unit 11 extracts sets of effective variables based on problem data indicating the combinatorial optimization problem. In the example of FIG. 1, three sets c1, c2, and c3 are extracted. The extracted sets c1, c2, and c3 are stored, for example, in a storage unit (not illustrated).

The generation unit 12 determines whether or not all the extracted sets of effective variable have been selected (step S3), and when it is determined that all the sets of effective variable have not been selected, the generation unit 12 selects an unselected sets of effective variables (step S4). The generation unit 12 generates the evaluation function with reduced constraint conditions based on the selected sets of effective variables (step S5). Thereafter, the operation unit 13 performs search processing for a ground state for the generated evaluation function (step S6), and the process is repeated from step S3.

In the example of FIG. 1, the generation unit 12 first generates the evaluation function with reduced constraint conditions based on the set c1, for example. In this case, the operation unit 13 executes the search for the ground state for the evaluation function generated based on the set c1. The solution obtained by the operation unit 13 and the value of the evaluation function corresponding to the solution are stored, for example, in the storage unit (not illustrated). Thereafter, the generation unit 12 generates an evaluation function with reduced constraint conditions based on the set c2, and the operation unit 13 executes the search for the ground state for the evaluation function generated based on the set c2. The same processing is performed for the set c3.

In the processing in step S3, when the generation unit 12 determines that all the sets of effective variables are selected, the operation unit 13 or an output unit (not illustrated) outputs the best solution among the solutions obtained for all the sets (step S7), and the operation of the optimization apparatus 10 ends.

For example, in the example of FIG. 1, the operation unit 13 outputs, as the best solution, the solution having the smallest value of the evaluation function among the solutions for the sets c1 to c3.

When the combinatorial optimization problem with the constraint conditions a to e as illustrated in FIG. 1 is converted into the evaluation function as it is, the evaluation function includes constraint terms pa, pb, pc, pd, and pe corresponding to the constraint conditions a to e in addition to the cost term cst (a value to be minimized). The potential shape (a graph in which the horizontal axis is the state (combination of all state variable values), and the vertical axis is the evaluation function value (H)) of such an evaluation function is complicated, and thus there is a high possibility that the solution is captured into the local solution.

As described above, when the evaluation function is generated by using the extracted set of effective variables, it is possible to reduce the number of constraint terms included in the evaluation function. In FIG. 1, an example is illustrated in which the constraint terms pc, pd, and pe may be deleted from the evaluation function. By generating the evaluation function with reduced constraint conditions in this manner, the potential shape of the evaluation function is relaxed (local maximum values and local minimum values is reduced) as illustrated in FIG. 1, thereby making it possible to improve the convergence to the optimal solution.

### Second Embodiment

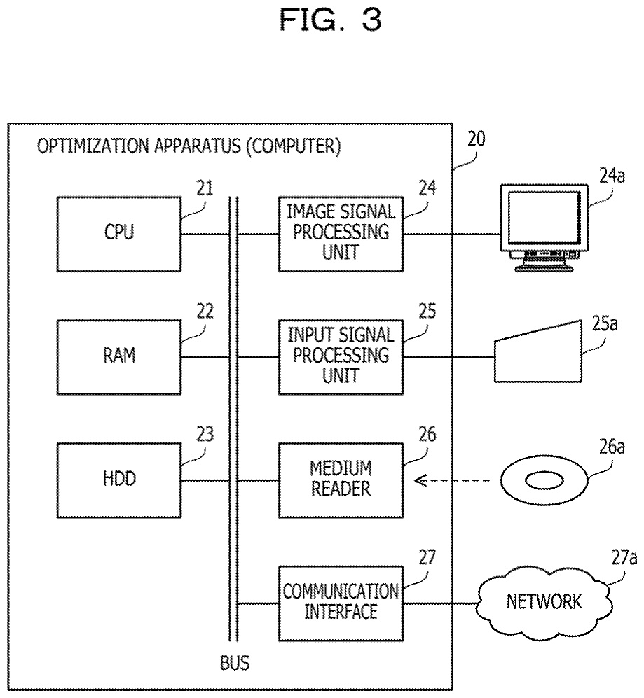

FIG. 3 is a diagram illustrating an example of hardware of an optimization apparatus according to a second embodiment.

An optimization apparatus 20 according to the second embodiment is a computer, for example, and includes a CPU 21, a random-access memory (RAM) 22, a hard disk drive (HDD) 23, an image signal processing unit 24, an input signal processing unit 25, a medium reader 26, and a communication interface 27. The above-described units are coupled to a bus.

The CPU 21 is a processor including an operational circuit that executes program instructions. The CPU 21 loads at least a part of a program and data stored in the HDD 23 into the RAM 22 and executes the program. The CPU 21 may include a plurality of processor cores, the optimization apparatus 20 may include a plurality of processors, and the processes, which will be described below, may be executed in parallel using a plurality of processors or processor cores. A set of the plurality of processors (multiprocessor) may be referred to as a “processor”.

The RAM 22 is a volatile semiconductor memory that temporarily stores a program executed by the CPU 21 and data used for operation by the CPU 21. The optimization apparatus 20 may include a type of memory other than the RAM, and may include a plurality of memories.

The HDD 23 is a non-volatile storage device that stores software programs such as an operating system (OS), middleware and application software, and data. The programs include a control program for the optimization apparatus 20, for example. The optimization apparatus 20 may include other types of storage devices such as a flash memory and a solid-state drive (SSD), and may include a plurality of non-volatile storage devices.

The image signal processing unit 24 outputs an image to a display 24a coupled to the optimization apparatus 20 in accordance with an instruction from the CPU 21. As the display 24a, a cathode ray tube (CRT) display, a liquid crystal display (LCD), a plasma display panel (PDP), an organic electro-luminescence (OEL) display or the like may be used.

The input signal processing unit 25 acquires an input signal from an input device 25a coupled to the optimization apparatus 20 and outputs the input signal to the CPU 21. As the input device 25a, a pointing device such as a mouse, a touch pad, a touch panel, or a trackball, a keyboard, a remote controller, a button switch and the like may be used. A plurality of types of input devices may be coupled to the optimization apparatus 20.

The medium reader 26 is a reading device that reads a program or data recorded on a recording medium 26a. As the recording medium 26a, for example, a magnetic disk, an optical disk, a magneto-optical disk (MO), a semiconductor memory and the like may be used. The magnetic disk includes a flexible disk (FD) and an HDD. The optical disk includes a compact disc (CD) and a digital versatile disc (DVD).

The medium reader 26 copies a program or data read from the recording medium 26a to another recording medium such as the RAM 22 or the HDD 23, for example. The read program is executed by the CPU 21, for example. The recording medium 26a may be a portable recording medium or may be used to distribute the program or data. The recording medium 26a and the HDD 23 may be referred to as computer-readable recording media.

The communication interface 27 is an interface that is coupled to a network 27a and communicates with another information processing apparatus via the network 27a. The communication interface 27 may be a wired communication interface coupled to a communication device such as a switch via a cable, or may be a wireless communication interface coupled to a base station via a wireless link.

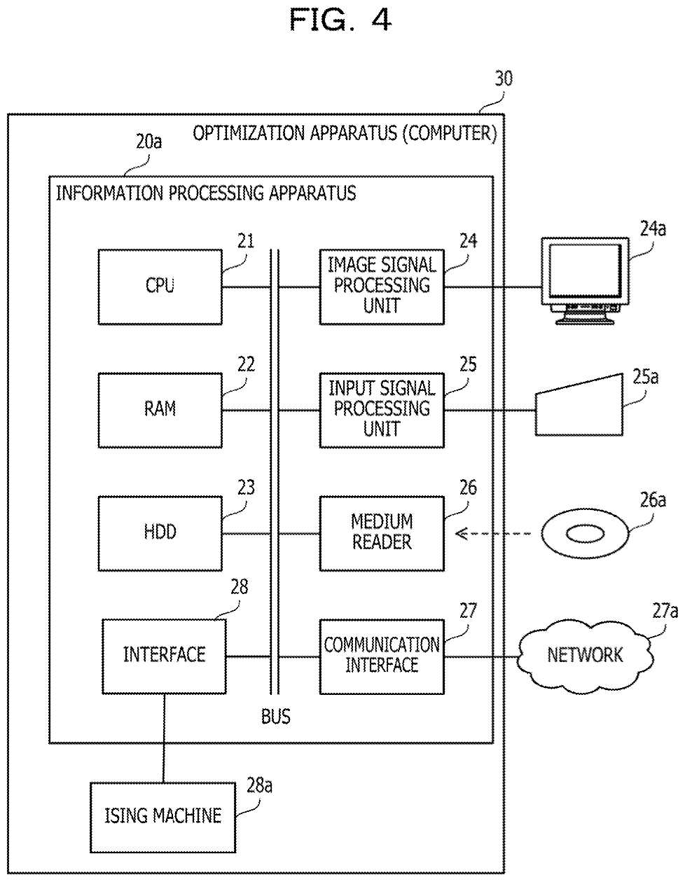

FIG. 4 is a diagram illustrating another example of hardware of the optimization apparatus according to the second embodiment. In FIG. 4, the same elements as those illustrated in FIG. 3 are denoted by the same reference signs.

An optimization apparatus 30 includes an information processing apparatus 20a and an Ising machine 28a. The information processing apparatus 20a has an interface 28. The interface 28 is coupled to the Ising machine 28a and allows data to be transmitted and received between the CPU 21 and the Ising machine 28a. The interface 28 may be a wired communication interface such as a Peripheral Component Interconnect (PCI) Express or may be a wireless communication interface.

The Ising machine 28a may be hardware that executes the simulated annealing method or the replica exchange method by using a digital circuit or may be hardware that performs quantum annealing.

Next, functions and process procedures of the optimization apparatuses 20 and 30 will be described.

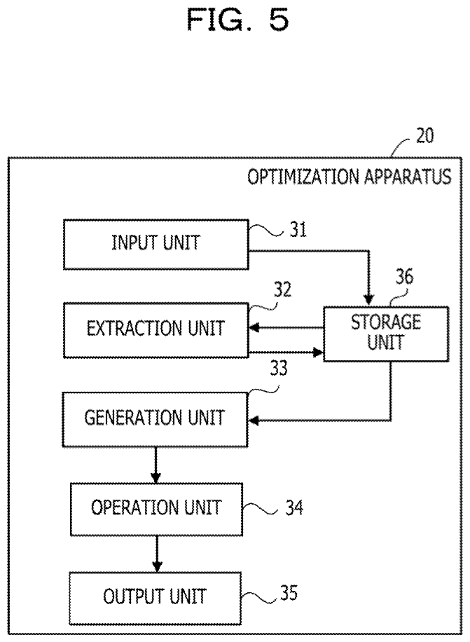

FIG. 5 is a block diagram illustrating a function example of the optimization apparatus according to the second embodiment.

Although the function example of the optimization apparatus 20 illustrated in FIG. 3 will be described below, the optimization apparatus 30 illustrated in FIG. 4 also have the same functions.

The optimization apparatus 20 includes an input unit 31, an extraction unit 32, a generation unit 33, an operation unit 34, an output unit 35, and a storage unit 36. The input unit 31, the extraction unit 32, the generation unit 33, the operation unit 34, and the output unit 35 may be implemented by using, for example, program modules executed by the CPU 21. When the optimization apparatus 30 illustrated in FIG. 4 is used, the Ising machine 28a functions as the operation unit 34 (or a part thereof). The storage unit 36 may be implemented by using a storage area secured in the RAM 22 or the HDD 23, for example.

The input unit 31 acquires problem data indicating the combinatorial optimization problem to be calculated, which is input by the input device 25a, for example. The acquired problem data is stored in the storage unit 36.

The extraction unit 32 extracts a set of variables satisfying a part of the constraint conditions of the combinatorial optimization problem based on the problem data acquired by the input unit 31 and stored in the storage unit 36. The extracted set of variables is stored in the storage unit 36.

The generation unit 33 generates the evaluation function with reduced constraint conditions based on the problem data stored in the storage unit 36 and the extracted set of the variables.

The operation unit 34 executes a search for a ground state for the generated evaluation function.

The output unit 35 outputs the best solution among the solutions searched by the operation unit 34 for all the sets of variables extracted by the generation unit 33 to, for example, the display 24a. The output unit 35 may store the best solution in the storage unit 36.

The storage unit 36 stores the sets of variables, the problem data, and the like extracted by the extraction unit 32.

Next, an example of the operations of the optimization apparatuses 20 and 30 (control method for the optimization apparatuses 20 and 30) according to the second embodiment will be described.

In the following, the CVRP will be described as an example of the combinatorial optimization problem to be calculated. As described above, the CVRP is a problem for obtaining a route that minimizes a total movement distance or the like based on various input variables when a demand is delivered (or collected) to a node by a transport vehicle (hereinafter referred to as a truck) waiting at a specific facility called a depot and returns to the depot again.

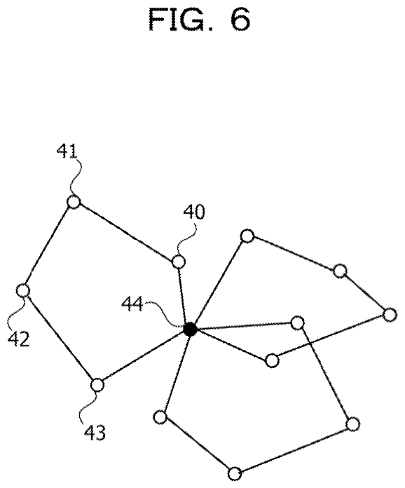

FIG. 6 is a diagram illustrating an example of a depot, nodes, and routes in a CVRP.

FIG. 6 illustrates an example of a plurality of nodes (such as a node 40, 41, 42, and 43), a depot 44, and routes coupling them.

The number of the depot may be plural, but is assumed to be one below. The plurality of trucks may be distinguished as those having different properties, but are not distinguished below. Both a case where the truck collects demands from the nodes and a case where the truck delivers the demands to the nodes may be considered, but in the following, it is assumed that the truck delivers the demands to the nodes. The range (time frame) of the arrival time of the truck at each node may be designated, but in the following, it is assumed that the arrival time is not designated. As the place where the demand occurs, a place (for example, between nodes) other than the nodes may be set, but in the following, it is assumed that the demand occurs only in the nodes. As the demand, a condition (such as the size of an article) other than the amount of an item delivered by the truck may be considered, but in the following, it is assumed that the condition other than the amount of the item is not considered.

There are the following constraint conditions A to G as constraint conditions of the CVRP. (Constraint condition A) For all routes, the total value of the demands of the nodes excluding the depot on the route is within the maximum load capacity of one truck. (Constraint condition B) At all times, trucks pass through (visits) only one location (one node) on one route at the same time. (Constraint condition C) All nodes excluding the depot are passed through by trucks only once. (Constraint condition D) When a truck passes through a node excluding the depot on a route at a time (>0), the truck passes through any of the nodes on the route at one previous time. (Constraint condition E) After a truck passes through a node except the depot on a route at a time (<M (time for traveling around all nodes)), the truck passes through any of the nodes on the route at one subsequent time. (Constraint condition F) At all routes, trucks pass through the depot two times on the same route. (Constraint condition G) For all routes, trucks pass through only the depot at the start time and the end time.

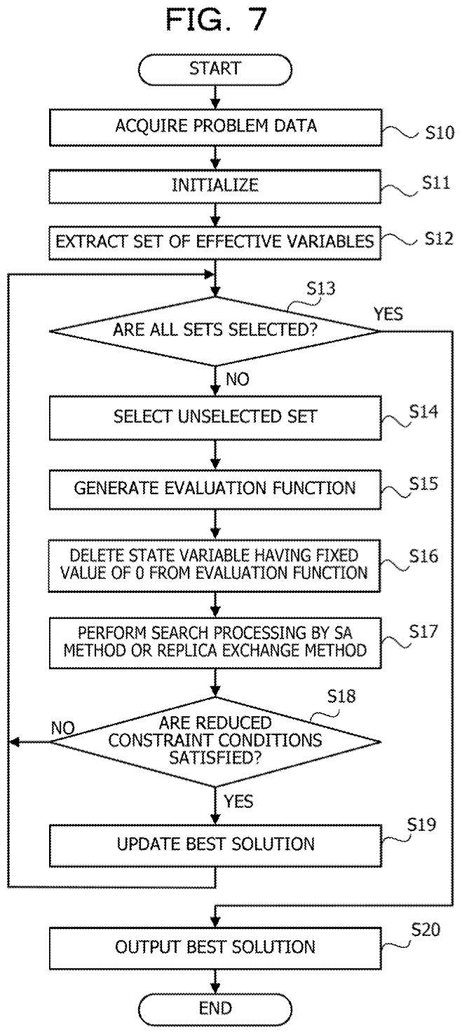

FIG. 7 is a flowchart illustrating a flow of an example of a control method for the optimization apparatus according to the second embodiment.

First, the input unit 31 acquires the problem data (step S10). When the CVRP is calculated as described above, the problem data includes various input variables such as the number of nodes, the demand of each node, the number of trucks, the maximum load capacity of the truck, the depot, and the distance between nodes.

The operation unit 34 initializes the minimum value of the evaluation function and all state variables included in the evaluation function (step S11). The values of all the state variables and the minimum value of the evaluation function that are candidates for a solution may be held in the operation unit 34 (for example, may be held in a register (not illustrated) or the like in the Ising machine 28a), or may be held in the storage unit 36 (the RAM 22 or the like).

Thereafter, the extraction unit 32 extracts sets of effective variables based on the problem data (step S12).

When the CVRP is calculated as described above, in the processing of step S12, the extraction unit 32 first sorts the demands, for example, in ascending order as follows.

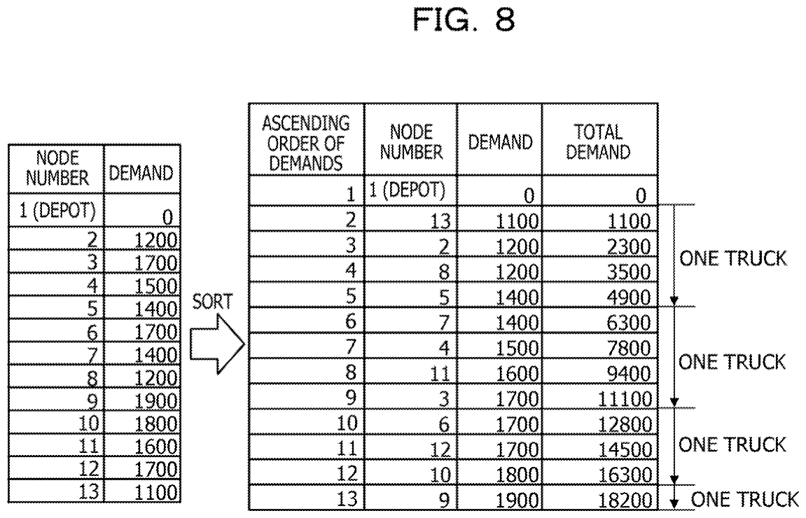

FIG. 8 is a diagram illustrating exemplary sorting of demands.

In the example of FIG. 8, an example is illustrated in which the demands in the depot and each of 12 nodes included in the problem data are sorted in ascending order (ascending order of demands). In the example of FIG. 8, the node number=1 is assigned to the depot as one of the nodes. The extraction unit 32 calculates, for each ascending order of demands, the total demand obtained by accumulating demands from the top of the sorted list.

When the number of trucks is four and the maximum load capacity of each truck is 6000, one truck may rotate up to four nodes, two trucks may rotate up to eight nodes, three trucks may rotate up to 11 nodes, and four trucks may rotate all 12 nodes.

The extraction unit 32 extracts a combination of the numbers of nodes that each of the four trucks is able to visit as a set of effective variables. In the example of FIG. 8, there are four combinations of the numbers of nodes. For example, there are a combination of 4, 4, 3, 1, a combination of 4, 4, 2, 2, a combination of 4, 3, 3, 2, and a combination of 3, 3, 3, 3. In the example of the first combination, as illustrated in FIG. 8, demands are delivered to four nodes having a node number=2, 5, 8, 13 in one truck, and demands are delivered to four nodes having a node number=3, 4, 7, 11 on another truck. Demands are delivered to three nodes having the node number=6, 10, 12 on yet another truck, and the demand is delivered to one node having the node number=9 on still another truck.

An example of a process procedure for extracting combinations of the numbers of nodes that each truck is able to visit will be described in more detail later.

By determining the combinations of the numbers of nodes that each truck is able to visit as described above, the constraint conditions D, E, F, and G are satisfied when the constraint conditions A, B, and C are satisfied. The reason for this will be described below.

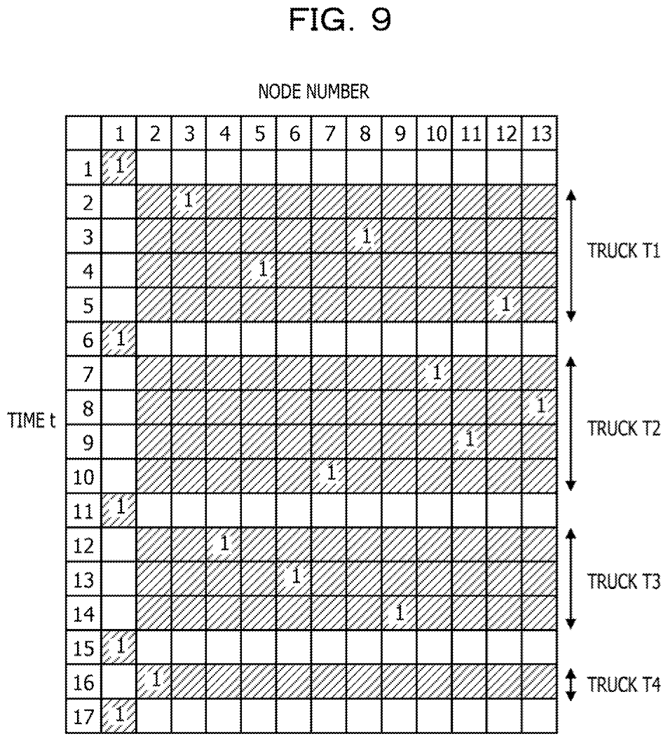

FIG. 9 is a diagram illustrating whether or not a truck is present at each node at each time when a combination of the numbers of nodes that each truck is able to visit is 4, 4, 3, 1.

Each cell in FIG. 9 represents a state variable (xₜᵢ) included in the evaluation function. When xₜᵢ=1, it indicates that the truck is at the node number=i at the time t, and when xₜᵢ=0, it indicates that the truck is not at the node number=i at the time t. In the example of FIG. 9, when the combination of the numbers of nodes is 4, 4, 3, 1, the cells corresponding to the nodes at which a truck may be present at each time are shaded.

In the example of FIG. 9, for the sake of convenience, each route is divided into different times, which means that one truck does not go around all routes, but delivery is performed by different trucks (trucks T1 to T4 in FIG. 9) for each route.

Since the truck is supposed to be at a depot (node number=1) which lies at the beginning and end of each route, the truck T1 is at the depot at time t=1 and 6, the truck T2 is at the depot at time t=6 and 11, the truck T3 is at the depot at time t=11 and 15, and the truck T4 is at the depot at time t=15 and 17 (xₜ₁=1). The other shaded cells represent state variables that are determined to be 0 or 1 by search processing described later. In the example of FIG. 9, an example of a cell (state variable) having a value of 1 determined by the search processing is illustrated. In consideration of constraint conditions F and G, since there is no truck at the time and the node corresponding to the unshaded cell, the cell represents a state variable having a value of 0.

In addition to the constraint conditions F and G, the constraint conditions D and E are also satisfied at the same time when the constraint condition B is satisfied, by the condition that the beginning and the end of each route are at the depot (node number=1) and the combination of the numbers of nodes that each of trucks T1 to T4 is able to visit.

For example, when the evaluation function is generated with the value of the state variable corresponding to the unshaded cell as a fixed value of 0, the constraint conditions D to G in the constraint conditions A to G may not be included in the evaluation function as constraint terms.

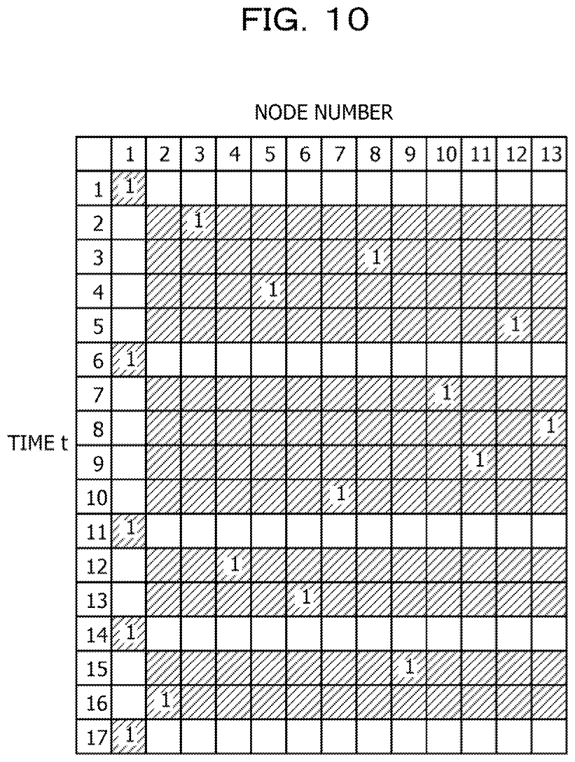

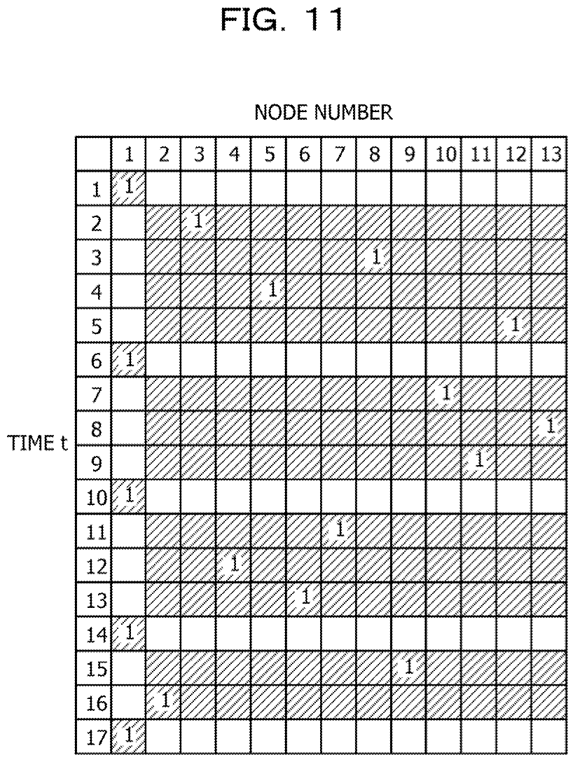

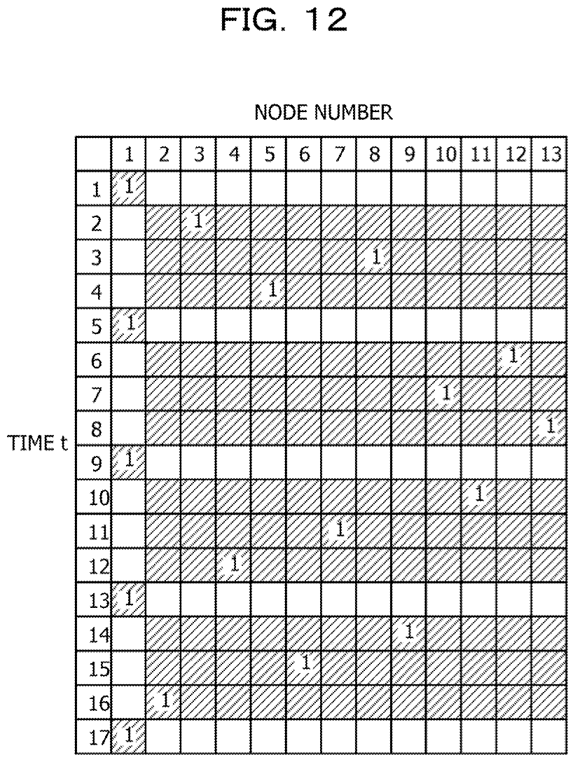

FIG. 10 is a diagram illustrating whether or not a truck is present at each node at each time when a combination of the numbers of nodes that each truck is able to visit is 4, 4, 2, 2. FIG. 11 is a diagram illustrating whether or not a truck is present at each node at each time when a combination of the numbers of nodes that each truck is able to visit is 4, 3, 3, 2. FIG. 12 is a diagram illustrating whether or not a truck is present at each node at each time when a combination of the numbers of nodes that each truck is able to visit is 3, 3, 3, 3.

As illustrated in FIGS. 10 to 12, nodes at which a truck may be present at each time differ depending on the extracted combination of the numbers of nodes that each truck is able to visit.

After the processing of step S12 as described above, the generation unit 33 determines whether or not all the extracted sets of effective variable have been selected (step S13), and when it is determined that all the sets of effective variable have not been selected, the generation unit 33 selects an unselected sets of effective variables (step S14). The generation unit 33 generates the evaluation function with reduced constraint conditions based on the selected sets of effective variables (step S15).

For example, the evaluation function including constraint terms corresponding to the constraint conditions A to C may be represented by the following Expression (1).

$$H = {\sum }_{l = 0}^{M - 1} {\sum }_{i = 0}^{N} {\sum }_{j = 0}^{N} {c}_{ij} {x}_{ti} {x}_{( t + 1 ) j} + {A ( {\sum }_{i = 0}^{{N}_{c 1}} {\sum }_{i = 1}^{N} {d}_{i} {x}_{i 1} + {y}_{r 1} - Q )}^{2} … {( {\sum }_{t = {M}_{R - 3} + 1}^{{M}_{R}} {\sum }_{i = 1}^{N} {d}_{i} {x}_{ti} + {y}_{R} - Q )}^{2} + B {\sum }_{i = 0}^{M} {( {\sum }_{i = 0}^{n} {x}_{ti} - 1 )}^{2} + C {\sum }_{i = 1}^{N} {( {\sum }_{t = 0}^{M} {x}_{ti} - 1 )}^{2} \\ {x}_{0 i} = 0 , {x}_{{M}_{rj} i} = 0 , ∀ j ∈ \{ 1 , … , R \} , ∀ i ∈ \{ 1 , … , N \} \qquad ( 1 )$$

In Expression (1), A is a coefficient of a constraint term corresponding to the constraint condition A, B is a coefficient of a constraint term corresponding to the constraint condition B, C is a coefficient of a constraint term corresponding to the constraint condition C, and the constraint becomes stronger as the value is set to be larger. Q is the maximum load capacity of one truck, cu is the distance between the node with the node number=1 and the node with the node number=j, dᵢ is the demand at the node with the node number=i, and yᵣ₁ and y_{R} are auxiliary variables (variables that represent the conditional expression represented by the inequality). Note that M is a time taken to go around all nodes, N is the number of all nodes, and xc is a state variable indicating whether or not the truck is at node number=i at time t. “r1” and Mᵣ₁ of yᵣ₁ represent the number of nodes that the first truck visits, “R” of y_{R} represents the number of routes (equal to the number of trucks), and M_{R} represents the number of nodes the last truck visits.

Next, the generation unit 33 deletes a state variable having a fixed value of 0 (a variable corresponding to the unshaded cell described above) from the evaluation function (step S16).

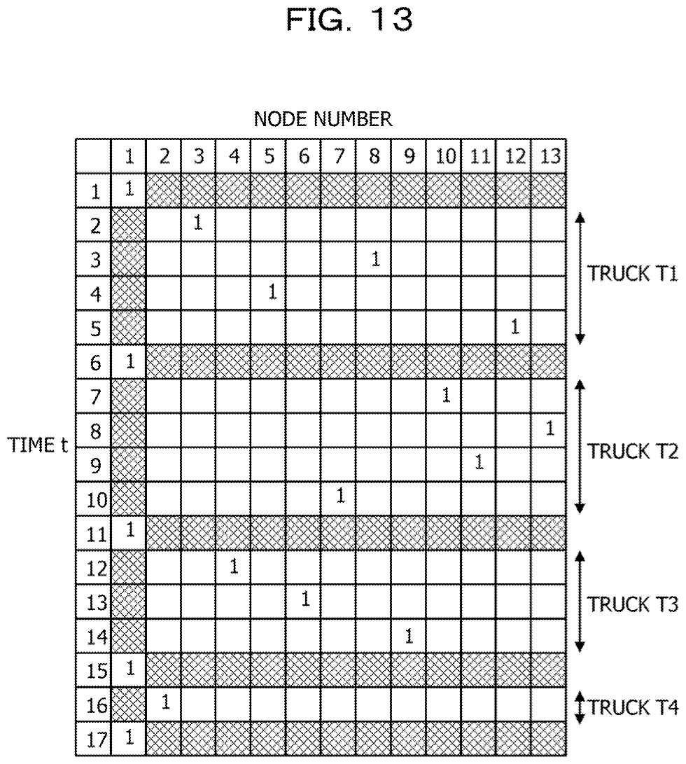

FIG. 13 is a diagram illustrating an example of state variables to be deleted.

In the example of FIG. 13, the cells corresponding to the state variables to be deleted are shaded. Although the value of the state variable corresponding to such a cell is fixed to 0 as described above, since the state variable does not contribute to the value of the evaluation function, it is possible to delete the state variable itself. Since the number of state variables (the number of bits) may be reduced by deleting such state variables, it is possible to narrow the search space and to shorten the time taken to perform the search processing.

Thereafter, the operation unit 34 performs the search processing (search for the ground state) on the generated evaluation function by the simulated annealing method (denoted as the SA method in FIG. 7) or the replica exchange method (step S17). The operation unit 34 may perform the search for the ground state by a quantum annealing method.

The operation unit 34 determines whether or not the state (the combination of values of all variables of the evaluation function), which is the solution output as the search result, satisfies the reduced constraint conditions (the constraint conditions A to C in the above example) (step S18). When the reduced constraint conditions are not satisfied, the process is repeated from step S13, and when the reduced constraint conditions are satisfied, the operation unit 34 updates the best solution (solution candidate) (step S19). For example, in the processing of step S19, when the value of the evaluation function when the solution output as the search result is obtained is smaller than the minimum value of the evaluation function so far, the update is performed. In this case, the minimum value of the evaluation function is also updated. When the value of the evaluation function when the solution output as the search result is obtained is equal to or larger than the minimum value of the evaluation function so far, the update is not performed. After the processing in step S19, the process is repeated from step S13.

When it is determined that all sets are selected in the processing of step S13, the output unit 35 outputs the best solutions so far held, for example, in the operation unit 34 or the storage unit 36 as a solution for the combinatorial optimization problem (step S20). In this way, the process of the optimization apparatus 20 and 30 ends. The solution is output and displayed on the display 24a, for example.

The order of the process of the optimization apparatuses 20 and 30 is not limited to the example of FIG. 7, and the order of the processes may be changed as appropriate.

Next, an example of a procedure of a process for extracting combinations of the numbers of nodes that each truck is able to visit in the CVRP will be described.

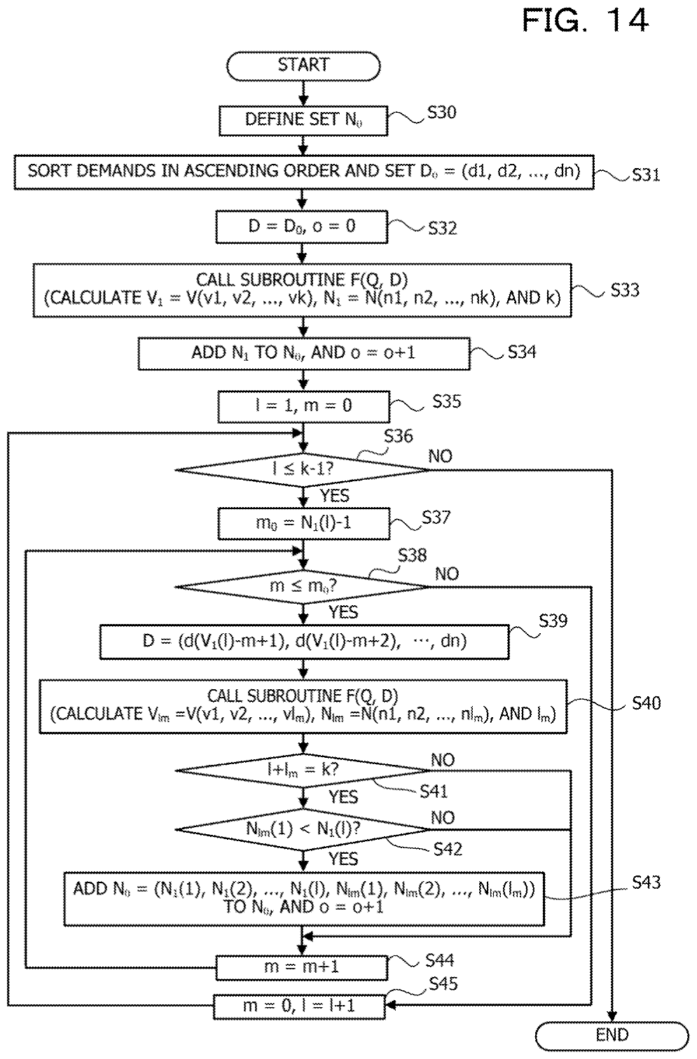

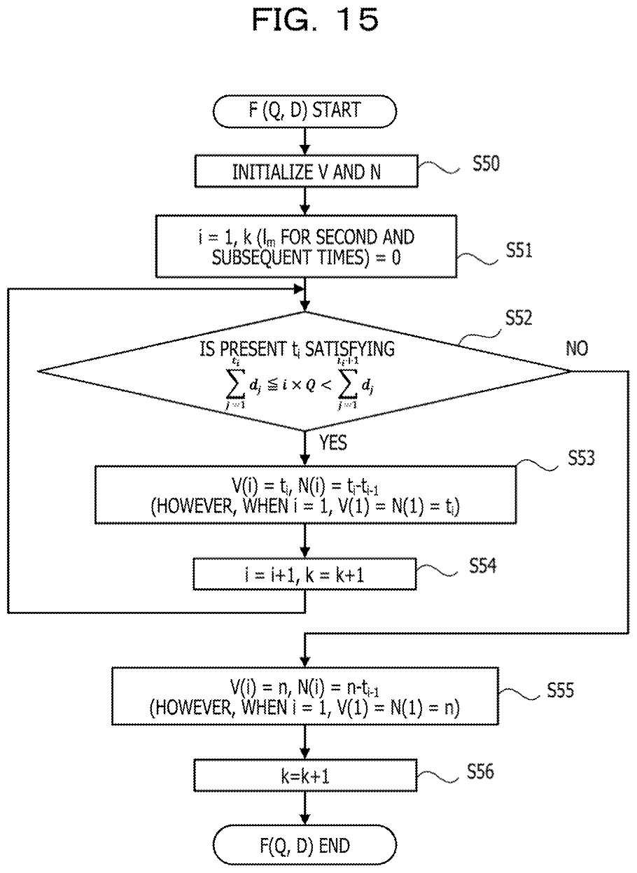

FIGS. 14 and 15 are flowcharts illustrating an example of a procedure of a process for extracting combinations of the numbers of nodes that each truck is able to visit. In the following, the number of nodes is denoted by n (not including the depot), and the maximum load capacity of one truck is denoted by Q.

The extraction unit 32 first defines N₀ as a set of combinations of the numbers of nodes to be obtained (step S30), sorts the demands of the respective nodes in ascending order, and sets D₀=(d1, d2, . . . , dn) (step S31). The extraction unit 32 initializes a vector D having n elements to D₀ and initializes a variable o to 0 (step S32).

Thereafter, the extraction unit 32 calls a subroutine F(Q, D) to be described later (step S33). In the processing of the subroutine F(Q, D), V₁=V(v1, v2, . . . , vk) representing the cumulative number of nodes visited by k trucks, N₁=N(n1, n2, . . . , nk) representing the combination of the numbers of nodes visited, and k are calculated.

After the processing of the subroutine F(Q, D), the extraction unit 32 adds N₁ to N₀ to set o=o+1 (step S34). The extraction unit 32 initializes a variable l to 1 and a variable m to 0 (step S35). The extraction unit 32 determines whether or not l≤k−1 (step S36). When the extraction unit 32 determines that l≤k−1 is not satisfied, the extraction unit 32 ends the extraction processing.

When it is determined that l≤k−1 is satisfied, the extraction unit 32 sets m₀ indicating a recombination range of the combination of the numbers of nodes to N₁(l)−1 (step S37). The extraction unit 32 determines whether or not m≤m₀ (step S38). When it is determined that m≤m₀ is not satisfied, the extraction unit 32 sets m=0 and l=l+1 (step S45), and thereafter, the process is repeated from step S36.

When it is determined that m≤m₀ is satisfied, the extraction unit 32 initializes the vector D as a vector having the number of elements [n−{V₁(l)−m}], and sets D=(d(V₁(l)−m+1), d(V₁(l)−m+2), . . . , dn) (step S39).

Thereafter, the extraction unit 32 calls the subroutine F(Q, D) again (step S40). In the processing of the subroutine F(Q, D) of step S40, Vₗₘ=V(v1, v2, . . . , vlₘ) representing the cumulative number of nodes, Nₗₘ=(n1, n2, . . . , nlₘ) representing the combinations of the numbers of nodes, and lₘ are calculated.

After the processing of the subroutine F(Q, D), the extraction unit 32 determines whether or not l+lₘ=k (step S41). When it is determined that l+lₘ=k is not satisfied, the extraction unit 32 sets m=m+1 (step S44), and then the process is repeated from step S38.

When it is determined that l+lₘ=k is satisfied, the extraction unit 32 determines whether or not Nₗₘ(1)<N₁(l) is satisfied (step S42). When it is determined that Nₗₘ(1)<N₁(l) is not satisfied, the extraction unit 32 performs the processing of step S44, and then the process is repeated from step S38.

When it is determined that Nₗₘ(1)<Nₗ(l) is satisfied, the extraction unit 32 adds the vector N₀=(N₁(1), N₁(2), . . . , Nₗ(l), Nₗₘ(1), Nₗₘ(2), . . . , Nₗₘ(lₘ)) to N₀ and sets o=o+1 (step S43).

After the processing of step S43, the extraction unit 32 performs the processing in step S44, and then the process is repeated from step S38.

In the processing of subroutine F(Q, D) illustrated in FIG. 15, the extraction unit 32 first initializes the vector V and the vector N (step S50), and sets the variable i to 1 and sets the variable k to 0 (step S51). In the second and subsequent processing of the subroutine F(Q, D) (the processing of step S40), lₘ is used instead of the variable k (the same applies to the following).

When the value is incremented by 1 from 1, the extraction unit 32 determines whether or not a variable ti satisfying the relationship of the following Expression (2) is present (step S52).

$${\sum }_{j = 1}^{{t}_{l}} {d}_{j} ≦ i \times Q < {\sum }_{j = 1}^{{t}_{i} + 1} {d}_{j} \qquad ( 2 )$$

In Expression (2), d is the j-th element of the vector D. For example, in the processing of step S39, when D=(d(V₁(l)−m+1), d(n−V₁(l)−m+2), . . . , dn), dₗ=d(V₁(l)−m+1) and d₂=d(n−V₁(l)−m+2) are satisfied.

When it is determined that the variable t satisfying the relationship of Expression (2) is present, the extraction unit 32 sets V(i)=tᵢ and N(i)=tᵢ−tᵢ₋₁ (step S53). However, when i=1, the extraction unit 32 sets V(1)=N(1)=tᵢ. Thereafter, the extraction unit 32 sets i=i+1 and k=k+1 (step S54), and then the process is repeated from step S52.

When it is determined that no variable 4 satisfying the relationship of Expression (2) is present, the extraction unit 32 sets V(i)=n and N(i)=n−tᵢ₋₁, and substitutes the values into each element of the vectors V and N (step S55). However, the extraction unit 32 sets V(1)=N(1)=n when i=1. Thereafter, the extraction unit 32 sets k=k+1 (step S56), and ends the processing of the subroutine F(Q, D).

For example, when the above-described process is applied to the example as illustrated in FIG. 8, V₁=V(v1, v2, . . . , vk)=V(4, 8, 11, 12) and N₁=N(n1, n2, . . . , nk)=N(4, 4, 3, 1) are calculated by the processing of the subroutine F(Q, D) in step S33. In this case, assuming that l=1 and m=0, in the vector D used in the processing of the subroutine F(Q, D) in step S40, since V₁(1)=4, D=(d(V₁(1)−m+1) and d(V₁(l)−m+2), . . . , dn)=(d5, d6, . . . , d12). At this time, in Expression (2), for example, the calculation is performed by using d5 as d₁ and d6 as d₂.

With the process procedure above, the combinations of the numbers of nodes that each truck may visit may be extracted.

The process for extracting the combinations of the numbers of nodes that each truck is able to visit is not limited to the examples in FIGS. 14 and 15, and the process order may be changed as appropriate.

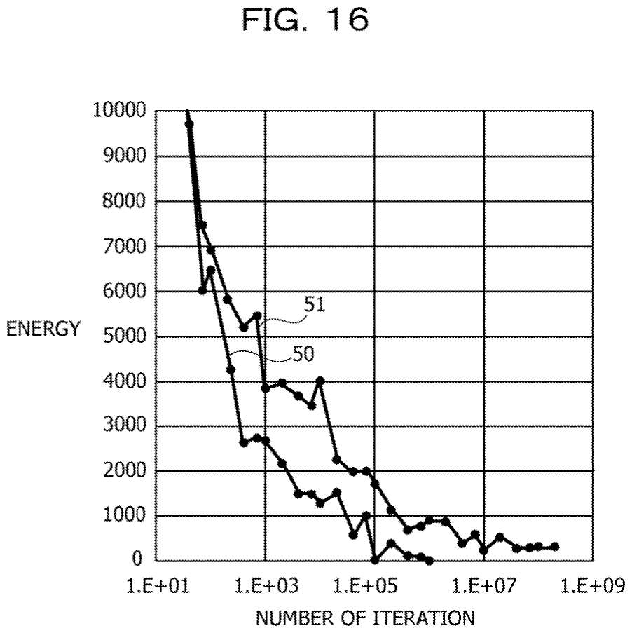

FIG. 16 is a diagram illustrating an example of a calculation result of a CVRP in a case of k=4, n=12, Q=6000. The horizontal axis represents the number of iteration of the search processing by the operation unit 34, and the vertical axis represents the value (energy) of the evaluation function.

A calculation result 50 indicates a calculation result when an evaluation function with reduced constraint conditions is used by the processing, and a calculation result 51 indicates a calculation result when an evaluation function including all the constraint conditions as constraint terms is used for comparison. The hardware used for the calculation is the Ising machine 28a having a scale of 1024 bits for executing the simulated annealing method using digital circuit.

As seen from the calculation result 50, when the evaluation function with reduced constraint conditions is used, the state (combination of values of variables included in the evaluation function) converges to the optimal solution (ground state) when the number of iteration is around 10⁶ (1.E+06). In terms of calculation time, the solution may converge to the optimal solution in about several seconds. On the other hand, as seen from the calculation result 51, when the evaluation function including all the constraint conditions as the constraint terms is used, the state does not converge to the optimal solution even when the number of iteration is 10⁸ (1.E+08), and the optimal solution may not be obtained within a practical time.

As a result of calculation for the problem (k=4, n=21) having a larger scale, the optimal solution was obtained within a practical time.

As described above, according to the optimization apparatuses 20 and 30 of the second embodiment, a set of variables satisfying a part of the constraint conditions is extracted, and an evaluation function with reduced constraint conditions is generated based on the set. Since the number of constraint terms included in the evaluation function is reduced, the potential shape of the evaluation function is relaxed, thereby making it possible to improve the convergence to the optimal solution. Since the number of state variables may be reduced by deleting, from the evaluation function, a state variable having a fixed value of 0 among the plurality of state variables included in the evaluation function, it is possible to narrow the search space and to shorten the time taken to perform the search processing.

As described above, the above processing details may be realized by causing the optimization apparatus 20 or 30 to execute a program.

The program may be recorded on a computer-readable recording medium (such as the recording medium 26a). As the recording medium, for example, a magnetic disk, an optical disk, a magneto-optical disk, a semiconductor memory, and the like may be used. The magnetic disk includes an FD and an HDD. The optical disk includes a CD, a CD-recordable (R)/rewritable (RW), a DVD, and a DVD-R/RW. The program may be recorded and distributed on a portable recording medium. In that case, the program may be copied from the portable recording medium to another recording medium (such as the HDD 23) and executed.

Although one aspect of an optimization apparatus, a control method for the optimization apparatus and a control program for the optimization apparatus according to the present disclosure has been described based on the embodiments above, such an aspect is a mere example and is not limited to the above description.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optimization apparatus, comprising:
a memory; and
a processor coupled to the memory and configured to:
extract a set of variables satisfying a part of constraint conditions of a combinatorial optimization problem based on problem data indicating the combinatorial optimization problem,
generate an evaluation function with the reduced constraint conditions based on the problem data and the extracted set of variables, and
execute a search for a ground state for the generated evaluation function.

2. The optimization apparatus according to claim 1, wherein the processor is configured to
delete a state variable having a fixed value based on the extracted set of variables, among a plurality of state variables included in the evaluation function.

3. The optimization apparatus according to claim 1, wherein the processor is configured to:
when a plurality of the sets of variables are extracted, generate the evaluation function with the reduced constraint conditions based on each of the plurality of sets,
execute, for the evaluation function generated based on each of the plurality of sets, the search for the ground state, and
output a search result that minimizes a value of the evaluation function.

4. The optimization apparatus according to claim 1, wherein the processor is configured to:
when the combinatorial optimization problem is a routing problem of a plurality of nodes, determine a combination of the numbers of nodes that each of a plurality of transport vehicles is able to visit based on a maximum load capacity of each of the plurality of transport vehicles included in the problem data, and a demand amount in each of the plurality of nodes, and
determine the set of variables to be extracted based on the combination of the numbers of nodes.

5. An optimization method executed by a computer, the optimization method comprising:
extracting a set of variables satisfying a part of constraint conditions of a combinatorial optimization problem based on problem data indicating the combinatorial optimization problem,
generating an evaluation function with the reduced constraint conditions based on the problem data and the extracted set of variables, and
executing a search for a ground state for the generated evaluation function.

6. The optimization method according to claim 5, the optimization method further comprising
deleting a state variable having a fixed value based on the extracted set of variables, among a plurality of state variables included in the evaluation function.

7. The optimization method according to claim 5, the optimization method further comprising:
when a plurality of the sets of variables are extracted, generating the evaluation function with the reduced constraint conditions based on each of the plurality of sets,
executing, for the evaluation function generated based on each of the plurality of sets, the search for the ground state, and
outputting a search result that minimizes a value of the evaluation function.

8. The optimization method according to claim 5, the optimization method further comprising:
when the combinatorial optimization problem is a routing problem of a plurality of nodes, determining a combination of the numbers of nodes that each of a plurality of transport vehicles is able to visit based on a maximum load capacity of each of the plurality of transport vehicles included in the problem data, and a demand amount in each of the plurality of nodes, and
determining the set of variables to be extracted based on the combination of the numbers of nodes.

9. A non-transitory computer-readable storage medium storing a program that causes a computer to execute a process, the process comprising:
extracting a set of variables satisfying a part of constraint conditions of a combinatorial optimization problem based on problem data indicating the combinatorial optimization problem,
generating an evaluation function with the reduced constraint conditions based on the problem data and the extracted set of variables, and
executing a search for a ground state for the generated evaluation function.
